(19) United States
(12) Patent Application Publication
(10) Pub. No.: US 2009/0218412 A1
(43) Pub. Date: Sep. 3, 2009

(54) NON-CONTACT DISPENSING OF LIQUID DROPLETS

(75) Inventors: Mark David Wardle, Ringwood (AU); Andrew David Reynoldson, Ringwood (AU); David Charles Bailey, Ringwood (AU); Reno Cerra, Ringwood (AU)

Correspondence Address: FULWIDER PATTON LLP, HOWARD HUGHES CENTER, 6060 CENTER DRIVE, TENTH FLOOR, LOS ANGELES, CA, 90045, US

(73) Assignee: SGE Analytical Science Pty Ltd., Ringwood (AU)

(21) Appl. No.: 12/395,224

(22) Filed: Feb. 27, 2009

(30) Foreign Application Priority Data
Feb. 29, 2008 (AU) 2008901025

(51) Int. Cl. B05B 1/08

(52) U.S. Cl. 239/1; 239/102.1

(57) ABSTRACT

Apparatus and method for dispensing droplets of a liquid includes structure providing a passage along which the liquid may be delivered to form a droplet at an orifice. The structure is configured to propagate a shockwave to impact the droplet and thereby to displace it from the orifice, whereby the droplet is dispensed. The structure may provide an elongate passage to longitudinally receive a syringe needle positionable with its tip, and the orifice at the tip, at or adjacent on open end of the passage, one or more needle guides to locate the needle in the passage, which is of greater cross-section than the needle at the open end, and a seal arrangement to substantially seal the passage about the needle at a position displaced from the open end of the passage whereby to define a chamber between the position and the open end. A syringe drive device may have a head adapted to be coupled to a syringe and means to operate the syringe to dispense droplets by free-fall from the syringe tip orifice, and structure adapted to be selectively coupled to the head and/or to a syringe carried thereby.

### TECHNICAL FIELD

The present invention relates generally to the displacement of droplets of liquid from the end of needles, tubes or other liquid transportation media, and is more particularly concerned with the non-contact dispensing of liquid droplets.

### BACKGROUND OF THE INVENTION

The opposing forces of gravity and surface tension determine a droplet's shape and, in combination with the size of the orifice, the volume of the droplet. Typically, a liquid with high surface tension will remain at an orifice to form a droplet of several microliters before it breaks from the orifice and falls onto a substrate. If there is a requirement to dispense droplets of a volume less than the “free fall” volume, around 3 μl for aqueous media and other liquids that exhibit similar surface tension, one known approach is to use contact dispensing. Contact dispensing involves the process of bringing the droplet and substrate in close proximity so that the droplet touches the substrate and is released from the orifice and preferentially spreads onto the substrate. Hence, to achieve accurate and repeatable contact dispensing it is necessary to use precision actuators to bring the droplet and substrate in close proximity. Any inaccuracy is cumulative and before long results in either physical contact between the tip at the orifice and the substrate, or failure of the droplet to contact the substrate.

An alternative to contact dispensing is non-contact dispensing. Various non-contact dispensing means exist including pressure-dependent solenoid-activated valves (for example the Lee Co.'s miniature solenoid valves and Innovadyne's low volume pipetting technology), a piezoelectric activated drop-on-demand ink-jet dispenser (for example MicroFab Technologies), aerosol dispensing (Bio-Dot's Air Jet Quanti) and charged electrostatic dissociation. There is also a known system in which a set volume of liquid is blown out of a capillary by an air pulse in the capillary.

In another system, described in U.S. Pat. No. 6,270,019, a sheath of pressurised air directed from an annular opening about the droplet orifice surrounds the dispensed droplet during its flight to an adjacent substrate. The principal purpose of this air sheath is to contain satellite portions that break away from the droplet within the discharged sheath to prevent them from falling onto areas of the substrate outside the desired zone, a problem that commonly arises in the absence of the sheath.

The choice of which non-contact dispensing means to use is influenced by what features are required for droplet displacement—for example the volume of the droplet, the density of droplets in an array, the speed of droplet dispensing.

Most of the non-contact dispensing systems are fully integrated and dedicated automated systems requiring significant capital expenditure and training of personnel for their routine operation. There is a need in the market for a simplified device that preferably can be adapted for addition to a typical contact dispensing system to offer the user a non-contact dispensing mode.

It is an object of the invention to provide an improved apparatus and method to carry out non-contact dispensing of liquid droplets.

### DISCLOSURE OF THE INVENTION

The present invention provides for the dispensing of droplets from an orifice by means of a shock wave that displaces the droplet from the orifice, without any requirement for the droplet to contact a substrate prior to its displacement from the orifice.

The present invention provides, in a first aspect, apparatus for dispensing droplets of a liquid that comprises structure providing a passage along which the liquid may be delivered to form a droplet at an orifice. The structure is configured to propagate a shockwave to impact the droplet and thereby to displace the droplet from the orifice, whereby the droplet is dispensed.

In a second aspect, the invention provides apparatus for dispensing droplets of a liquid that comprises structure providing an elongate passage to longitudinally receive a syringe needle positionable with its tip, and the orifice at the tip, at or adjacent on open end of the passage. One or more needle guides locate the needle in the passage, which is of greater cross-section than the needle at the open end. A seal arrangement substantially seals the passage about the needle at a position displaced from the open end of the passage, whereby to define a chamber between that position and the open end. The apparatus is configured to deliver to the chamber a shockwave that is propagated from the chamber at the open end to impact a droplet of the liquid at the orifice and thereby to displace the droplet from the orifice, whereby the droplet is dispensed.

In a third aspect, the invention provides a method for dispensing a droplet of a liquid, including:
delivering the liquid along a passage to form a droplet at an orifice that opens from the passage; and
generating a shockwave and propagating it to impact said droplet and thereby displace it from the orifice, whereby the droplet is dispensed.

In a fourth aspect, the invention provides apparatus for dispensing droplets of liquid, including a syringe drive device, having a head adapted to be coupled to a syringe and means to operate the syringe to dispense droplets by free-fall from the syringe tip orifice, and structure adapted to be selectively coupled to the head and/or to a syringe carried thereby. The structure is configured to propagate a shockwave to impact a droplet at the orifice that is too small to freefall, and thereby to displace the droplet from the orifice, whereby the droplet is dispensed.

Preferably, the shockwave is a pulse of a gas, most conveniently a pulse of air.

Preferably, the pulse is propagated to impact the droplet from adjacent the orifice so that the droplet is displaced in a direction directly away from the orifice. In an embodiment, the shockwave is arranged to displace the droplet in a direction generally along the axis of the passage. Typically in use, this axis will be generally vertical so that the orifice is at the lower end of the passage and/or syringe needle.

In a practical embodiment, the syringe drive device has a motorised drive for aspirating and dispensing liquid at said orifice.

Advantageously, the surface of the passage and/or syringe needle is treated adjacent the orifice to facilitate droplets forming at the orifice.

The volume of each droplet is preferably in the range 5 nanoliters to 5 microliters. A droplet size of particular interest is around 50 nanoliters.

Means is preferably provided to generate the shockwave and to deliver it to said structure. This means may typically include a solenoid drive and a controller which allows selective modification of the solenoid operation and thereby of the form of the shockwave.

To maintain integrity of the droplet shape, the droplet is typically displaced within a distance of 0.5 mm to 5 mm of the substrate. The shockwave air pulse generation system is preferably configured to allow a sufficient impact force to be applied with a minimal amount of turbulence resulting in the vicinity of the droplet landing area.

### BRIEF DESCRIPTION OF THE DRAWINGS

The invention will now be further described, by way of example only, with reference to the accompanying drawings, in which:

FIG. 1 is a schematic view of a syringe drive device in which the syringe is coupled to an embodiment of apparatus for the non-contact dispensing of droplets in accordance with the concepts of the present invention;

FIG. 2 is an axial cross section of the droplet dispensing apparatus depicted in FIG. 1;

FIG. 3 is a view similar to FIG. 2, but with the needle in situ; and

FIG. 4 is an axial cross section of the shockwave generator for generating a shockwave to displace the droplet from the dispensing orifice in the arrangement depicted in FIG. 1.

### EMBODIMENTS OF THE INVENTION

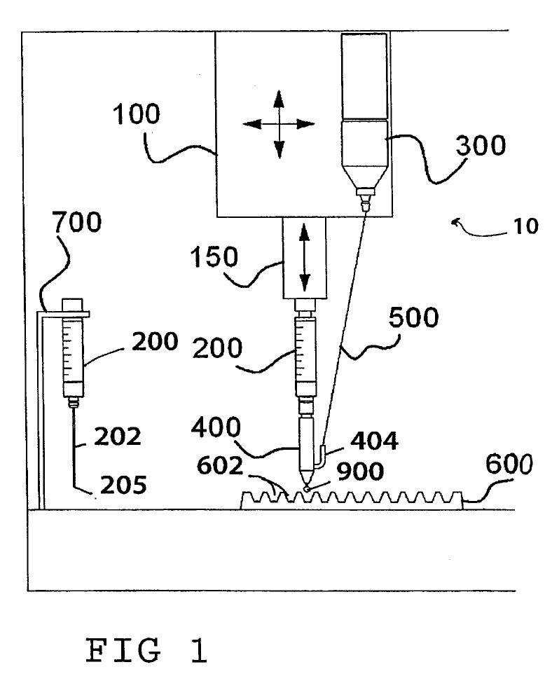

The syringe drive device 10 schematically shown in FIG. 1, which may, for example, be a multi-axis auto sampler, includes a carriage 100 translatable (by means not detailed) in all three X, Y and Z dimensions for selectively picking up syringes 200 from a syringe stand 700, and then, by means of the drive 150, operating the picked up syringe to aspirate sample liquid at one station and then dispense droplets at another station. The dispensing station is represented by a substrate 600 with multiple sample recesses 602 in which a droplet of the sample liquid is deposited in turn. Where the required droplet size is greater than the freefall volume, typically about 3 μl for aqueous media and other liquids having a similar surface tension, droplets can be dispensed directly by freefall from the orifice at the tip 205 of the needle 202.

For the purpose of dispensing smaller droplets, there is provided a non-contact dispenser device 400 that comprises an embodiment of apparatus incorporating concepts of the present invention. Non-contact dispenser device 400 is also designed to be held at the syringe stand 700 and to be picked up by syringe drive device 100 by being coupled to the lower end of syringe 200 and then moved into position at the dispensing station above substrate 600, as illustrated in FIG. 1.

Associated with non-contact dispenser device 400 is a shockwave generator 300 which is mounted on the translator carriage 100 and is operable by a controller to deliver shockwaves in the form of pulses of air to device 400 via an air tube or other communication means 500.

In a typical operation, syringe drive 150 will be operated to pick up, from syringe stand 700, a syringe 200 of known volume per known stroke length, and then to displace the syringe to a sample vial (not shown). Syringe drive 150 is then operated to drive the syringe needle tip, including an orifice at the tip, through septa into the vial, after which the syringe plunger is driven to aspirate the desired volume of sample into syringe 200 via the orifice in needle 202. The syringe needle is then withdrawn from the sample vial via the septa which wipes any sample from the orifice. The translator system now moves the syringe drive and the syringe 200 to pick up a non-contact dispenser device 400 from syringe holder 700 and the air line 500 is connected to the dispenser ready for dispensing of droplets onto substrate 600.

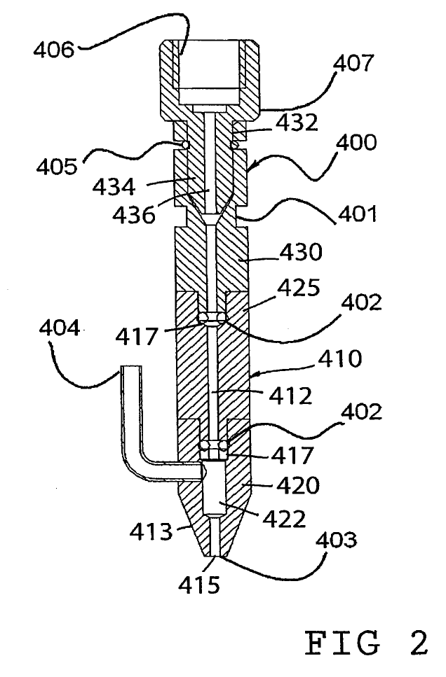

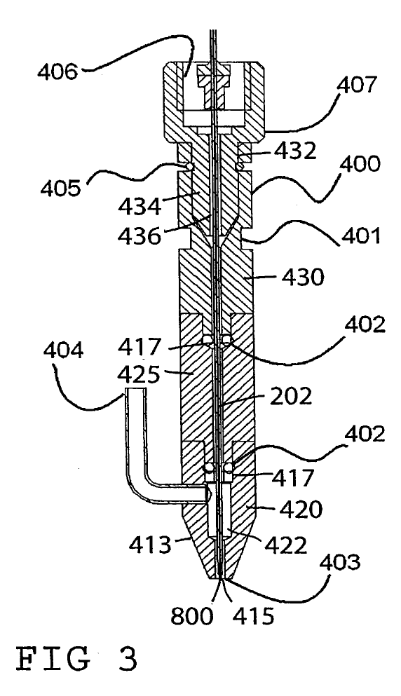

With particular reference to FIG. 2, non-contact dispenser device 400 has an elongate generally cylindrical barrel 410 with an axially extending passage 412 that opens at both ends of the barrel. In the case of the lower end, the open end 415 of the passage is in a flat face forming the tip 403 of a conical end portion 413 of barrel 410. Passage 412 is dimensioned to receive needle 202 of syringe 200 such that there is some space about the needle (FIG. 3), and in particular passage 412 is of greater cross-section than the needle at open end 415. This needle is located, indeed centered, in passage 412, and in the open bottom end 415 of the passage, by a pair of axially spaced O-rings 402 that serve as needle guides. O-rings 402 are accommodated in cavities 417 formed by dividing barrel 410 into three interlocking segments 420, 425, 430, as illustrated in FIG. 2.

A counterbore enlargement of passage 412 in tip barrel segment 420 forms a co-axial, axially symmetrical plenum chamber 422 to which air pulses are delivered via communication line 500 and a fixed tube 404 that opens radially into chamber 422 at its rear end. O-ring 402 at the lower end forms a seal arrangement to substantially seal passage 412 about the needle at a position displaced from open end 415, whereby to define plenum chamber 422 between this position and open end 415.

For easy coupling to dispenser device 400, the syringe 200 is fitted with a connector 407 having a threaded socket 406 by which it is mounted to the outer end of the syringe barrel. A male part 434 of connector 407 engages a mating socket 432 on the rearmost barrel segment 430 of dispenser 400. Disengagable coupling of the parts is latched by a spring clip 405 on barrel segment 430. It can be seen from FIG. 2 that the male part 434 of connector 407 includes a central bore 436 aligned with passage 412.

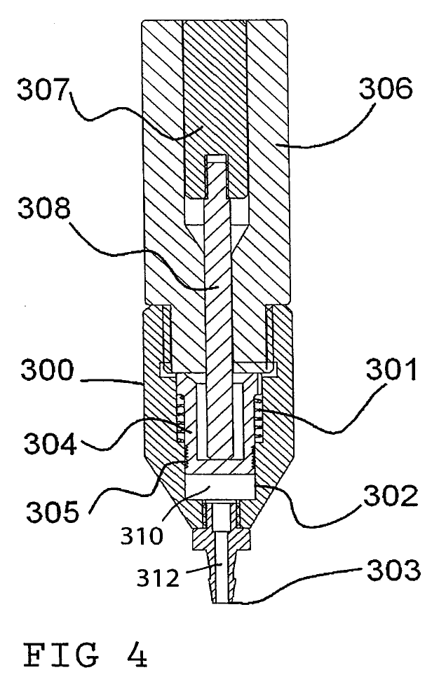

Shockwave generator 300 is a solenoid actuated device and is illustrated in detail in FIG. 4. A 12-volt solenoid 306 axially drives a plunger 307 that is coupled in turn to a push rod 308. The tip of push rod 308 internally engages piston 304 but is not actively connected to the piston. Piston 304 is in turn slideable within a cylinder 302 but biased outwardly and upwardly in the cylinder chamber 310 by a light helical compression spring 301. The piston 304 is sealed to the chamber wall by a labyrinth seal 305, while chamber 310 has an outlet passage 312 co-axial with the chamber and opposite the piston. The outlet passage 312 has a relatively small cross section, leading to a tip 303 of the cylinder at which passage 312 is connected to communication line 500.

Shockwave generator 300 outputs air pulses at tip 303 as follows. A controller (not shown) transmits 12-volt pulses to solenoid 306. The consequent rapid movement of the push rod 308 forces piston 304 sharply to the end of cylinder chamber 310. The speed with which the piston travels, in conjunction with the labyrinth seal 305, causes a rapid rise in pressure in chamber 310. This pressure generates a shockwave in the form of a pulse of air that exits the generator at the tip 303 and travels down the communication line 500 to plenum chamber 422 of dispenser 400. The piston 304 is held against the end of chamber 310 for the duration of the solenoid activation pulse. When the pulse ceases, the piston returns to its original position due to the minimal force applied by the return spring 301.

The operation of dispenser 400 will now be described in greater detail. Once the syringe drive with its coupled syringe 200 and dispenser 400 is in the correct position over substrate 600, the aforementioned controller sends signals to syringe drive 150 to move the syringe plunger a known length to displace a known volume of sample from the orifice 800 of the needle 202, which forms a droplet 900 (FIG. 1) at orifice 800 just below the end 415 of passage 412. Typically, this volume is less than the freefall volume, for example 50 to 100 nanoliters, and so the droplet 900 is retained by surface tension effects on the exterior of the orifice.

The controller now sends the aforementioned pulse signal to the solenoid 306 of the shockwave generator 300, and an air pulse shockwave is delivered to plenum chamber 422. The shockwave is propagated about the needle along passage 412 to impact the droplet 900 (FIG. 1) on the end of the needle. By selective operation of piston 304, the shockwave is arranged to be sufficient to displace the droplet from the orifice, and to thereby dispense it onto substrate 600, but with an impact force such that no satellites form from the droplet and there is substantially no fragmentation of the droplet. Moreover, it is desirable that the air pulse is such that there is no or very little turbulence in the vicinity of the droplet landing area.

It may be advantageous, depending on the liquid being dispensed, to treat the surface of the needle 202 adjacent its orifice 800 to create the correct environment for droplet formation. Typically, this treatment might involve polysiloxane chemistry to prepare the surface for creating the preferred contact angle between the liquid and the surface.

It has been found that the illustrated apparatus is capable of dispensing droplets of the order of 50 to 70 nanoliters at high repetition rates with high volume accuracy and no or minimal droplet fragmentation. Displacement of droplets as small as 5 to 10 nanoliters is thought to be achievable.

We claim:

1. Apparatus for dispensing droplets of a liquid, comprising:
structure providing a passage along which the liquid may be delivered to form a droplet at an orifice;
wherein said structure is configured to propagate a shockwave to impact said droplet and thereby to displace the droplet from the orifice, whereby the droplet is dispensed.

2. Apparatus according to claim 1 wherein said structure is configured to propagate a shockwave comprising a pulse of gas.

3. Apparatus according to claim 2 wherein said structure configured to propagate a shockwave is arranged to propagate the pulse to impact the droplet from adjacent the orifice so that the droplet is displaced in a direction directly away from the orifice.

4. Apparatus according to claim 3 wherein said structure configured to propagate a shockwave is arranged to displace the droplet in a direction generally along the axis of the passage.

5. Apparatus according to claim 1, wherein the surface of the passage and/or syringe needle is treated adjacent the orifice to facilitate droplets forming at the orifice.

6. Apparatus according to claim 1, further comprising a shockwave generator for generating the shockwave and delivering it to said structure.

7. Apparatus according to claim 6 wherein said shockwave generator includes a solenoid drive and a controller that allows selective modification of the solenoid operation and thereby of the form of the shockwave.

8. Apparatus for dispensing droplets of a liquid, comprising:
structure providing an elongate passage to longitudinally receive a syringe needle positionable with its tip, and the orifice at the tip, at or adjacent on open end of the passage;
one or more needle guides to locate the needle in the passage, which is of greater cross-section than the needle at said open end; and
a seal arrangement to substantially seal the passage about the needle at a position displaced from said open end of the passage, whereby to define a chamber between said position and said open end;
wherein said apparatus is configured to deliver to said chamber a shockwave that is propagated from the chamber at said open end to impact a droplet of the liquid at said orifice and thereby to displace the droplet from the orifice, whereby the droplet is dispensed.

9. Apparatus according to claim 8 wherein said apparatus is configured to propagate a shockwave comprising a pulse of gas.

10. Apparatus according to claim 9 wherein said apparatus configured to propagate a shockwave is arranged to propagate the pulse to impact the droplet from adjacent the orifice so that the droplet is displaced in a direction directly away from the orifice.

11. Apparatus according to claim 10 wherein said apparatus configured to propagate a shockwave is arranged to displace the droplet in a direction generally along the axis of the passage.

12. Apparatus according to claim 8, wherein the surface of the passage and/or syringe needle is treated adjacent the orifice to facilitate droplets forming at the orifice.

13. Apparatus according to claim 8, further comprising a shockwave generator for generating the shockwave and delivering it to said structure.

14. Apparatus according to claim 8 wherein said shockwave generator includes a solenoid drive and a controller that allows selective modification of the solenoid operation and thereby of the form of the shockwave.

15. Apparatus according to claim 13 wherein said one or more needle guides and said seal arrangement include a common O-ring about said passage.

16. Apparatus according to claim 8 wherein said one or more needle guides and said seal arrangement include a common O-ring about said passage.

17. Apparatus for dispensing droplets of liquid, comprising:
a syringe drive device, having a head adapted to be coupled to a syringe and means to operate the syringe to dispense droplets by free-fall from the syringe tip orifice; and
structure adapted to be selectively coupled to the head and/or to a syringe carried thereby;
wherein said structure is configured to propagate a shockwave to impact a droplet at said orifice that is too small to freefall, and thereby to displace the droplet from the orifice, whereby the droplet is dispensed.

18. A method for dispensing a droplet of a liquid, comprising:
delivering the liquid along a passage to form a droplet at an orifice that opens from the passage; and
generating a shockwave and propagating it to impact said droplet and thereby displace it from the orifice, whereby the droplet is dispensed.

19. A method according to claim 18 wherein said shockwave comprises a pulse of gas.

20. Apparatus according to claim 19 wherein the pulse impacts the droplet from adjacent the orifice so that the droplet is displaced in a direction directly away from the orifice.

21. Apparatus according to claim 18 wherein said shockwave displaces the droplet in a direction generally along the axis of the passage.
